(19) United States
(12) Patent Application Publication
(10) Pub. No.: US 2003/0204422 A1
(43) Pub. Date: Oct. 30, 2003

(54) Systems and methods for facilitating fulfillment of regulatory requirements

(76) Inventor: Hans-Linhard Reich, Middletown, NJ (US)

Correspondence Address: BUCKLEY, MASCHOFF, TALWALKAR, & ALLISON, 5 ELM STREET, NEW CANAAN, CT, 06840, US

(21) Appl. No.: 10/135,621

(22) Filed: Apr. 30, 2002

(51) Int. Cl. G06F 17/60

(52) U.S. Cl. 705/7

(57) ABSTRACT

Systems and methods are provided to facilitate the fulfillment of regulatory requirements. According to some embodiments, information associated with a user is determined, one or more regulatory requirements are determined based at least on the information, one or more unfulfilled regulatory requirements of the one or more regulatory requirements are determined based at least on the information, and an indication of the one or more unfulfilled regulatory requirements is presented to the user.

### FIELD

The present invention relates to the fulfillment of regulatory requirements. In particular, the present invention relates to systems and methods to facilitate the tracking and/or fulfillment of regulatory requirements.

### BACKGROUND

Many industries subject their member companies and workers to regulatory requirements. These requirements may be enacted by governmental or industry-affiliated agencies, may be mandatory or optional, and may be applied with varying degrees of specificity. As an example of the latter characteristic, an agency may subject all industry employees to a particular requirement and may also subject all management-level employees to an additional requirement.

In some industries, regulatory requirements applicable to companies and workers are quite complex. For example, a company may be subject to requirements issued by several different agencies and/or parent companies, with each requirement having a different compliance deadline. Moreover, each of the company's employees maybe subject to requirements enacted by several different agencies, parent companies, or the company itself, with the applicability of some requirements dependent on one or more of the employee's corporate position, job activities and geographical location. Companies may face harsh penalties if they fail to comply with mandatory ones of these requirements.

The securities industry is faced with a particularly onerous web of regulatory requirements. NASD Regulation, Inc., (NASDR) a subsidiary of the National Association of Securities Dealers, is charged with regulating the securities industry and oversees virtually all U.S. stockbrokers and brokerage firms. NASDR implements a continuing education program with support and guidance of the Securities and Exchange Commission (SEC) and the North American Securities Administrators Association. The program calls for a Firm Element and a Regulatory Element. The Firm Element requires brokers/dealers to establish a training process for keeping employees up to date on job- and product-related subjects. The process should be established by considering the size, structure, business scope, and regulatory concerns of the broker/dealer. The Regulatory Element, in contrast, requires computer-based training in broadly-applicable subject matter within one hundred twenty days of a person's second registration anniversary date and every three years thereafter.

NASDR maintains the qualification, employment, and disclosure histories of the more than half a million registered securities employees of member firms through the Web Central Registration Depository (CRD) system. The Web CRD system provides paperless, online versions of previously-manual functions to a company's compliance administrator. These functions include completion of employees' U-4 registration forms, submission of the completed forms, and determination of whether employees' registrations are lacking formal requirements such as fingerprint cards.

The Web CRD system also provides limited functions relating to compliance deadlines. According to one function, a company's compliance administrator queries the system to identify employees for whom a compliance deadline will fall within a given future period of time. This function also allows an administrator to view upcoming compliance deadlines for a particular employee. Using another function, an administrator instructs the Web CRD system to transmit to the administrator, a certain number of days prior to a compliance deadline, an electronic mail notification of the deadline.

Each of the deadline-related functions provided by the Web CRD system relies on an administrator to communicate with an employee regarding the fulfillment of regulatory requirements. Such reliance is both inefficient and prone to error. Moreover, the compliance deadlines that are of concern to the Web CRD system are only those relating to the Regulatory Element, rather than those that may be company-specific. This latter drawback precludes the Web CRD system as a suitable solution for facilitating company-specific regulatory requirements.

In view of the foregoing, what is needed is a system to efficiently facilitate fulfillment of regulatory requirements. Such a system may be used in conjunction with regulatory requirements unrelated to the securities industry.

### SUMMARY

To address the foregoing, embodiments of the present invention concern a system, a method, an apparatus, a computer-readable medium storing processor-executable process steps, and means to determine information associated with a user, determine one or more regulatory requirements based at least on the information, determine one or more unfulfilled regulatory requirements of the one or more regulatory requirements based at least on the information, and present an indication of the one or more unfulfilled regulatory requirements to the user.

Embodiments of the present invention also provide a user interface for determining regulatory requirements which includes an identification area for receiving information identifying a user, and an unfulfilled requirements area for presenting to the user one or more unfulfilled regulatory requirements determined based at least on the user and on fulfillment activity information associated with the user.

Some embodiments of the foregoing features may provide efficient fulfillment of regulatory requirements. The efficiency may result in improved risk control, reduced capital requirements, reduced insurance premiums, litigation costs, and compliance department costs.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a topographic view of a network architecture according to some embodiments of the present invention.

FIG. 2 is a block diagram of an internal architecture of a user administration server according to some embodiments to the present invention.

FIG. 3 is a block diagram of an internal architecture of a user device according to some embodiments to the present invention.

FIG. 4 is a block diagram of an internal architecture of a regulatory agency server according to some embodiments to the present invention.

FIG. 5 is a block diagram of an internal architecture of a fulfillment provider server according to some embodiments to the present invention.

FIG. 6 is a representative view of a tabular portion of a user database according to some embodiments of the present invention.

FIG. 7 is a representative view of a tabular portion of a requirements database according to some embodiments of the present invention.

FIG. 8 is a representative view of a tabular portion of a regulatory agency database according to some embodiments of the present invention.

FIG. 9 is a representative view of a tabular portion of a fulfillment provider database according to some embodiments of the present invention.

FIG. 10 is a representative view of a tabular portion of a user information database according to some embodiments of the present invention.

FIG. 11 is a representative view of a tabular portion of a regulatory requirements database according to some embodiments of the present invention.

FIG. 12 is a representative view of a tabular portion of a fulfillment activity database according to some embodiments of the present invention.

FIG. 13 is a flow diagram of process steps to facilitate the fulfillment of regulatory requirements according to some embodiments of the present invention.

FIG. 14 is a representative view of an interface according to some embodiments of the present invention.

FIG. 15 is a representative view of an interface according to some embodiments of the present invention.

FIG. 16 is a representative view of an interface according to some embodiments of the present invention.

FIG. 17 is a representative view of an interface according to some embodiments of the present invention.

### DETAILED DESCRIPTION

System Architecture

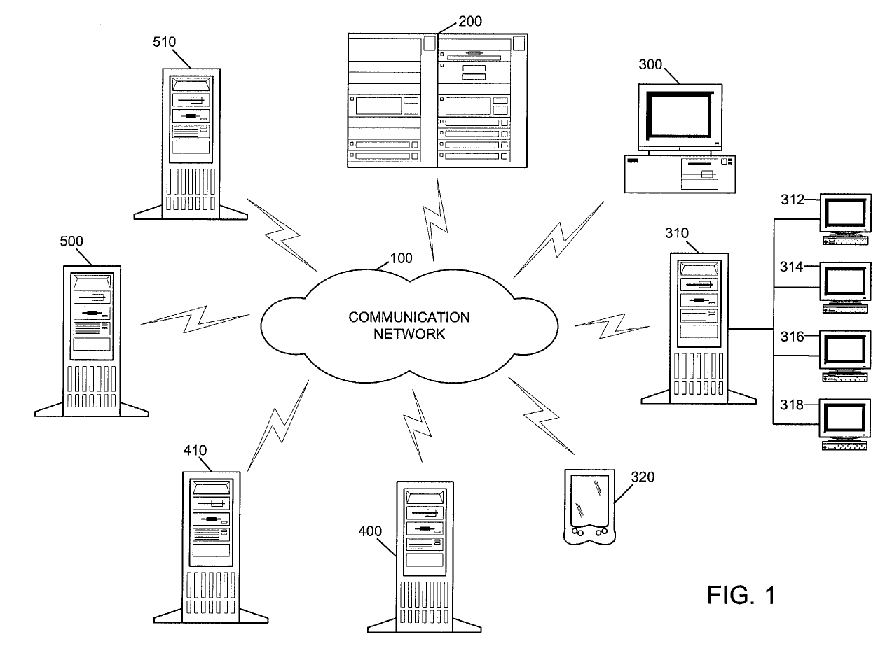

FIG. 1 illustrates a network architecture of a system according to some embodiments of the present invention. As shown, communication network 100 provides communication between user administration server 200, user devices 300 through 320, regulatory agency servers 400 and 410, and fulfillment provider servers 500 and 510.

Communication network 100 may comprise any number of different systems for transferring data, including a Local Area Network (LAN), a Metropolitan Area Network (MAN), a Wide Area Network (WAN), a proprietary network, a Public Switched Telephone Network (PSTN), a Wireless Application Protocol (WAP) network, a wireless LAN (e.g., in accordance with the Institute of Electrical and Electronics Engineers 802.11 standard), a Bluetooth network, an Infrared Radiation (IR) network, and/or an IP network such as the Internet, an intranet or an extranet. As used herein, the term “communications” can refer to wired and/or wireless communications as appropriate.

User administration server 200 is depicted as a mainframe server in FIG. 1, but may comprise any device or devices capable of performing process steps attributed to server 200 herein. User administration server 200 may provide user administration services for one or more entities. These user administration services may include one or more of facilitating fulfillment of regulatory requirements for one or more users, performing payroll functions, administering retirement plans, maintaining employee records, and other services. In this regard, user administration server 200 may be operated by a company's human resources department or by a company providing outsourced human resource functions. Similarly, user administration server 200 may be operated by an in-house fulfillment department or by a company providing services facilitating the fulfillment of regulatory requirements. For simplicity, the present description will consider a situation in which user administration server 200 provides services to a single company.

User administration server 200 is used in some embodiments to determine information associated with a user, determine one or more regulatory requirements based at least on the information, determine one or more unfulfilled regulatory requirements of the one or more regulatory requirements based at least on the information, and present an indication of the one or more unfulfilled regulatory requirements to the user. In one specific example, user administration server 200 stores information associated with company employees and receives a request for fulfillment information from one employee. In response to the request, server 200 accesses its own databases and regulatory agency servers 400 and 410 to determine regulatory requirements applicable to the employee. This determination may be based on stored information that is associated with the employee. User administration server 200 then determines fulfillment activities that have been completed by the user using the stored information or information received from an external device such as user device 300. Based on the completed activities and the determined regulatory requirements, user administration server 200 determines unfulfilled regulatory requirements and transmits the unfulfilled requirements to the employee. Also transmitted may be indications of fulfillment activities that are usable to completely or partially fulfill the unfulfilled regulatory requirements. This and other specific examples are discussed in more detail below.

User devices 300, 310 and 320 comprise a personal computer, a network server, and a personal digital assistant, respectively. User device 310 serves data to user terminals 312 through 318. These user devices are capable of communicating with user administration server 200 over communication network 100, and of presenting a user interface to a user in operation thereof. In some embodiments, such a user interface includes an identification area for receiving information identifying a user, and an unfulfilled requirements area for presenting to the user one or more unfulfilled regulatory requirements determined based at least on the user and on fulfillment activity information associated with the user.

Regulatory agency servers 400 and 410 each store information relating to regulatory requirements promulgated by one or more regulatory agencies. As described above, the stored information may be accessed by user administration server 200 to determine regulatory requirements associated with a user. In a specific example, regulatory agency server 400 stores regulatory requirements in association with user characteristics. Regulatory agency server 400 receives user characteristics from user administration server 200, identifies regulatory requirements corresponding to the characteristics, and transmits the requirements to user administration server 200. It should be noted that a regulatory requirement, for the purposes of the present description, need not be mandatory nor issued by a regulatory agency. That is, a regulatory requirement according to the present invention may be an optional “requirement” promulgated by a company with respect to its employees, or by an organization having no authority over its members.

Fulfillment provider servers 500 and 510 may be operated by one or more companies providing services for fulfilling regulatory requirements. Such services may include testing services, seminars, training seminars, or the like. In some embodiments, a single operator may operate one of regulatory agency servers 400 and 410 and fulfillment provider servers 500 and 510. Fulfillment provider servers 500 and 510 may store information relating to fulfillment activities in association with regulatory requirements that the associated fulfillment activities are usable to fulfill. In operation, regulatory requirements are transmitted to fulfillment provider server 500 by user administration server 200, fulfillment activities associated with the requirements are identified, and the identified fulfillment activities are transmitted to user administration server 200.

In other embodiments, the devices of FIG. 1 are connected differently than as shown. For example, some or all of the devices may be connected directly to one another. Of course, embodiments of the invention may include devices that are different from those shown. It should also be noted that although the devices are shown in communication with each other, the devices need not be constantly exchanging data. Rather, communication may be established when necessary and severed at other times or always available but rarely used to transmit data. Moreover, although the illustrated communication links appear dedicated, it should be noted that each of the links may be shared by other devices.

User Administration Server

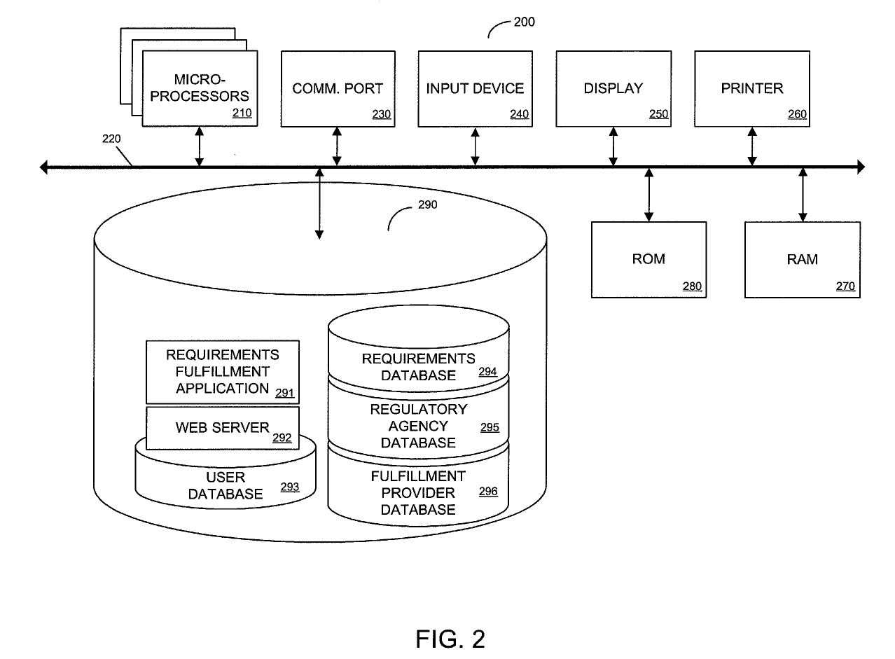

FIG. 2 is a block diagram of an internal architecture of user administration server 200 according to some embodiments of the invention. As illustrated, user administration server 200 includes microprocessors 210 in communication with communication bus 220. Microprocessors 210 may comprise RISC-based and other types of processors and are used to execute processor-executable process steps so as to control the elements of user administration server 200 to provide desired functionality.

Also in communication with communication bus 220 is communication port 230. Communication port 230 is used to transmit data to and to receive data from devices external to user administration server 200 such as devices 300 through 510. Communication port 230 is therefore preferably configured with hardware suitable to physically interface with desired external devices and/or network connections. For example, communication port 230 may comprise an Ethernet connection to a local area network through which user administration server 200 may receive and transmit information over the Web.

Input device 240, display 250 and printer 260 are also in communication with communication bus 220. Any known input device may comprise input device 240, including a keyboard, mouse, touch pad, voice-recognition system, or any combination of these devices. Of course, information may also be input to user administration server 200 from other devices via communication port 230. Display 250 may be an integral or separate CRT display, flat-panel display or the like used to display graphics and text in response to commands issued by microprocessors 210. Printer 260 may also present text and graphics to an operator, but in hardcopy form using ink-jet, thermal, dot-matrix, laser, or other printing technologies. Elements 240 through 260 are most likely used sparingly during operation of user administration server 200, but may be used by an operator for setup and administration.

RAM 270 is connected to communication bus 220 to provide microprocessors 210 with fast data storage and retrieval. In this regard, processor-executable process steps being executed by microprocessors 210 are typically stored temporarily in RAM 270 and executed therefrom by microprocessors 210. ROM 280, in contrast, provides storage from which data can be retrieved but to which data cannot be stored. Accordingly, ROM 280 is used to store invariant process steps and other data, such as basic input/output instructions and data used during boot-up of user administration server 200 or to control communication port 230. It should be noted that one or both of RAM 270 and ROM 280 may communicate directly with microprocessors 210 instead of over communication bus 220.

Data storage device 290 stores, among other data, processor-executable process steps of requirements fulfillment application 291. Microprocessors 210 therefore execute the process steps of requirements fulfillment application 291 in order to control user administration server 200 to facilitate the fulfillment of user requirements according to some embodiments of the present invention.

The process steps of requirements fulfillment application 291 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of processes according to embodiments of the present invention. Thus, embodiments of the present invention are not limited to any specific combination of hardware and software.

Process steps of Web server 292 are also stored in data storage device 290. These process steps may be executed by microprocessors 210 to transmit data to and to receive data from Web clients, such as Web browsers, over the Web. The data may include user information, regulatory requirements, fulfillment activity information, requests for information relating to unfulfilled regulatory requirements, unfulfilled regulatory requirements, and information relating to fulfillment activities usable to fulfill the unfulfilled regulatory requirements.

User database 293 of data storage device 290 includes characteristics associated with various users. The characteristics may include demographic information and information relating to a user's employment. The characteristics associated with a user are used in some embodiments to determine regulatory requirements applicable to the user.

Requirements database 294 stores regulatory requirements issued by a company operating user administration server 200. In this regard, the regulatory requirements stored in requirements database 294 are “internal” requirements that may not apply to users outside the company. Such requirements include those encompassed by the Firm Element described above. The “internal” requirements are stored in association with user characteristics so as to allow identification of those requirements that are applicable to a particular user.

Also stored in data storage device 290 are regulatory agency database 295 and fulfillment provider database 296. Regulatory agency database 295 includes information describing regulatory agency servers such as servers 400 and 410 and usable to access data maintained by such servers. According to some embodiments, the stored information is used to transmit user information to a server in order to determine regulatory requirements applicable to the user. Fulfillment provider database 296 similarly stores information describing servers operated by fulfillment providers and usable to access data maintained by the servers. In one specific example, user administration server 200 uses information stored in database 296 to transmit regulatory requirements to fulfillment provider server 500, in response to which server 500 transmits fulfillment activities usable to fulfill the regulatory requirements.

Also stored in data storage device 290 may also be other unshown elements that may be necessary for operation of user administration server 200, such as an operating system, a database management system, other applications, other data files, and “device drivers” for allowing microprocessors 210 to interface with devices in communication with communication port 230. These elements are known to those skilled in the art, and are therefore not described in detail herein.

User Device

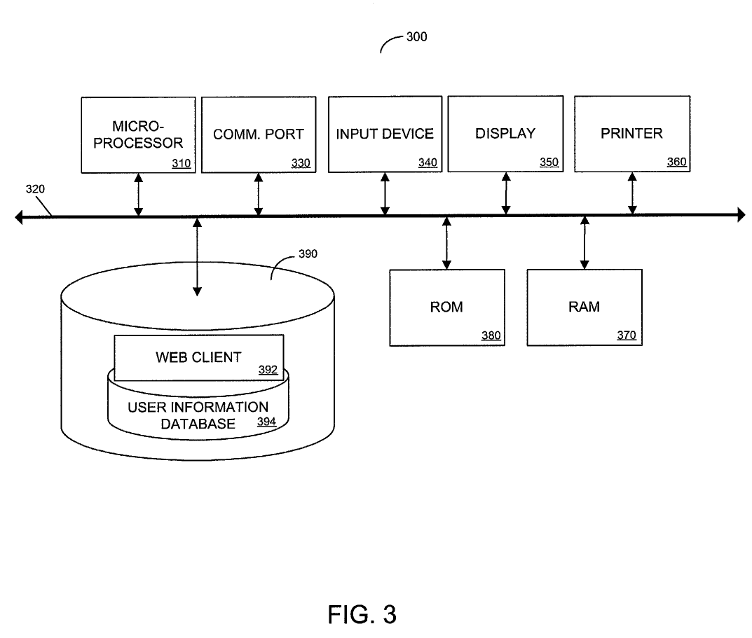

FIG. 3 illustrates several components of user device 300 according to some embodiments of the invention. It should be noted that these distinct components may comprise any of the specific examples offered with respect to identically-named components of user administration server 200. Of course, specific functions performed by the components may differ from the functions performed by the identically-named components.

For example, communication port 330 may be used to transmit requests for information to user administration server 200. In this regard, input device 340 may be used to request a user interface according to some embodiments of the invention by inputting customer information into a user interface presented by display 350 and to input commands to output the subsequently-received user interface via printer 360. Input device 340, display 350 and printer 360 may also be used in conjunction with other applications provided by user device 300 which are unrelated to the present invention.

Storage device 390 of user device 300 stores processor-executable process steps of Web client 392, such as a Web browser. The process steps may be executed by microprocessor 310 to allow communication with Web servers such as Web server 292 of user administration server 200. User information database 394 includes information identifying a user or users operating user device 300 and specifying fulfillment activities completed by the user or users. The information may be transmitted to user administration server 200 using Web client 392 to determine unfulfilled regulatory requirements associated with a user.

Storage device 390 may store one or more of other applications, data files, device drivers and operating system files needed to provide functions other than those directly related to the present invention. Such functions may include calendaring, e-mail access, word processing, accounting, presentation development and the like.

Regulatory Agency Server

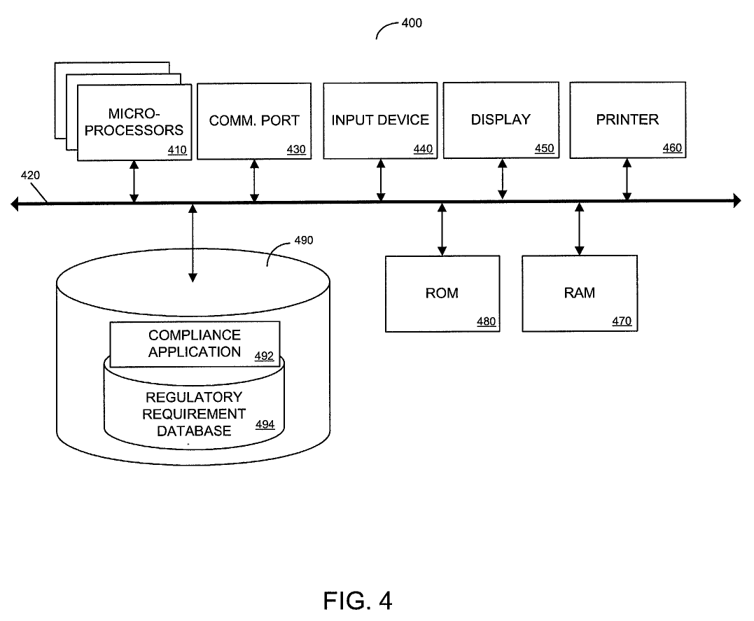

FIG. 4 is a block diagram of the internal components of regulatory agency server 400 according to some embodiments of the invention. Again, the illustrated components may comprise any of the specific examples given above with respect to identically-named components of user administration server 200 and/or user device 300.

In operation, process steps of compliance application 492 are executed by microprocessor 410 to determine regulatory requirements based on information associated with a user. This determination utilizes data stored in regulatory requirements database 494, which associates regulatory requirements with user characteristics. The regulatory requirements stored in database 494 may include requirements issued by one or more agencies and entities operating regulatory agency server 400. The stored information may be input using input device 440 or communication port 430.

It should be noted that compliance application 492 may include process steps usable to establish communication with and exchange data with requirements fulfillment application 291. In this regard, regulatory agency server 400 may include any software and/or hardware suitable to perform the steps described herein.

Fulfillment Provider Server

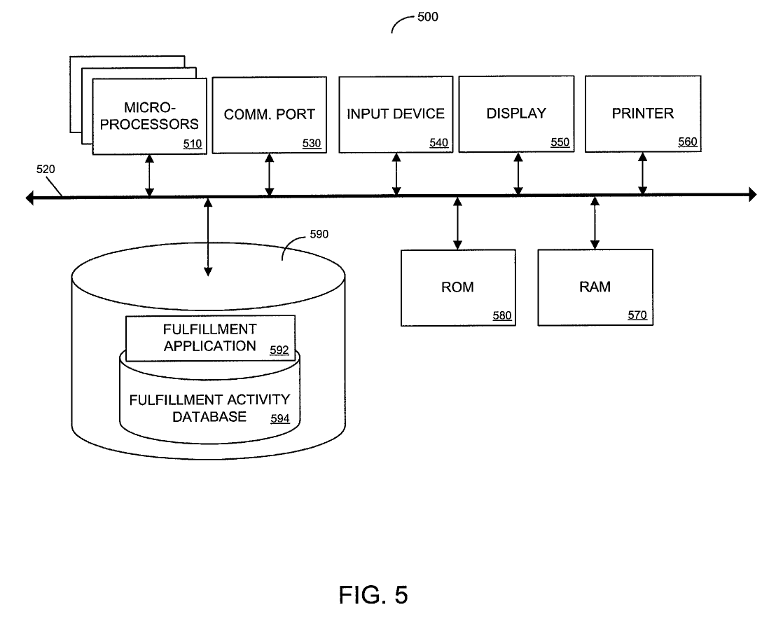

A block diagram of internal components of fulfillment provider server 500 according to some embodiments is illustrated in FIG. 5. Fulfillment application 592 includes process steps executable to receive a request for fulfillment activities usable to fulfill particular regulatory requirements, to determine the usable fulfillment activities, and to transmit the usable fulfillment activities to the requester. Accordingly, fulfillment activity database 594 stores information associating fulfillment activities with regulatory requirements that the activities are usable to fulfill.

Fulfillment provider server 500 may be operated by one or more fulfillment providers, and also includes any software and/or hardware suitable to establish communication with and exchange data with requirements fulfillment application 291.

Databases

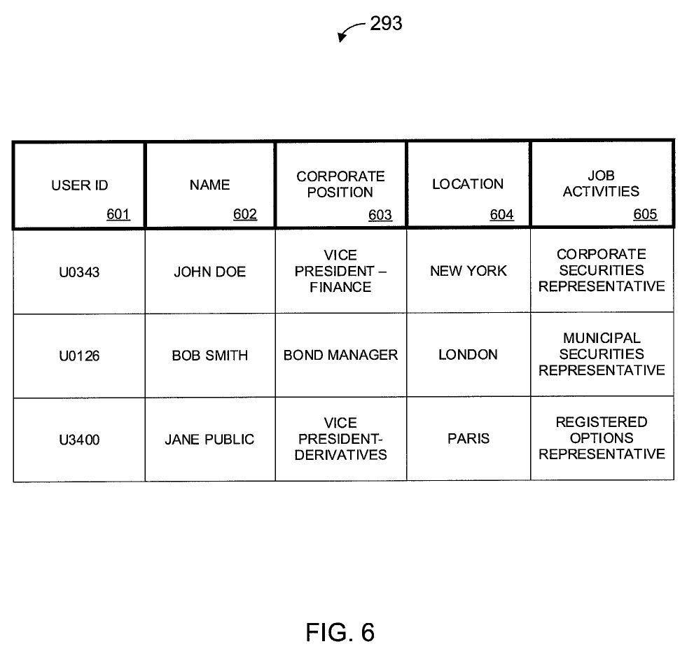

A tabular representation of a portion of user database 293 is shown in FIG. 6. As described above, the information stored in user database 293 is used in some embodiments to determine regulatory requirements applicable to a user. The information stored in user database 293 may be received from a variety of sources, including human resource databases, user device 300, and an operator manually inputting the information using input device 240. User database 293 of FIG. 6 includes several records, each consisting of several fields. The fields include user Id field 601, name field 602, corporate position field 603, location field 604 and job activities field 605.

User Id field 601 includes an identifier that may be used throughout the databases described herein to identify a particular user. In particular, the identifier associated with a record of user database 293 identifies a user associated with the characteristics of the record. Name field 602 specifies the user's name, while corporate position field 603 and location field 604 respectively identify the user's position in his employing company and the geographical location in which he works. Job activities field 605 describes the user's job activities for use in determining applicable regulatory requirements. In some embodiments, the job activities are described so as to conform to job descriptions defined by a regulatory agency. For example, in a case that a regulatory agency associates certain job descriptions with certain regulatory requirements, it may be useful to include directly corresponding descriptions in job activities field 605.

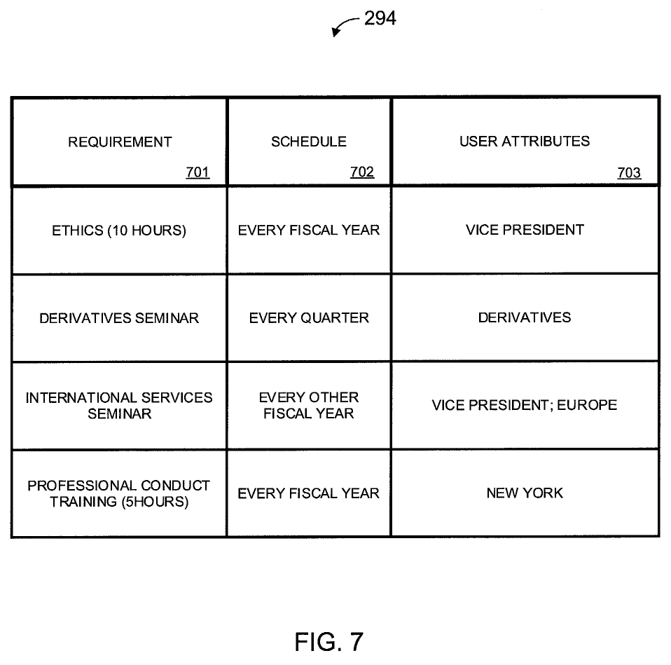

FIG. 7 illustrates a tabular representation of a portion of requirements database 294. Requirements database 294 stores regulatory requirements issued by a company operating user administration server 200. In some embodiments, these “internal” requirements might not apply to users outside the company. Each record of requirements database 294 includes requirement field 701, schedule field 702, and user attributes field 703.

Requirements field 701 of a record specifies a requirement associated with the record. Schedule field 702 specifies a period by which the associated requirement must (for mandatory requirements) or should (for optional requirements) be fulfilled. Lastly, user attributes field 703 describes users to whom the associated requirements apply. User attributes field may include one or more of any type of attribute, including those characteristics associated with users in user database 293. The information stored in database 294 may be received from human resource databases, a department in charge of maintaining Firm Element procedures, a parent company, or other sources.

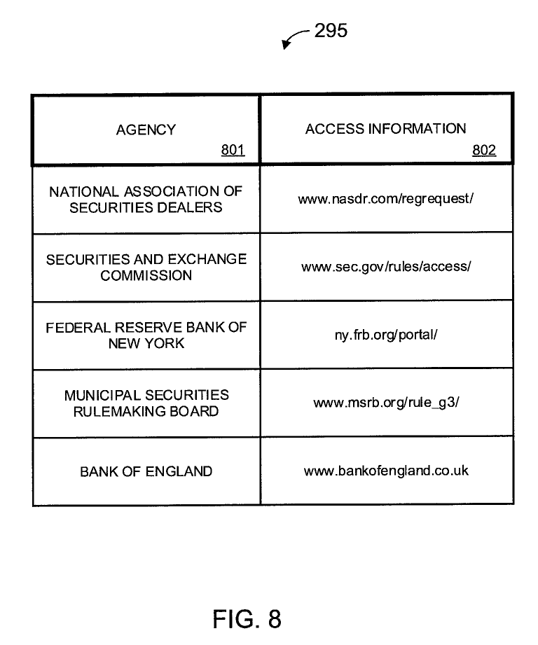

A tabular representation of a portion of regulatory agency database 295 is shown in FIG. 8. Regulatory agency database 295 includes information that is usable to access data maintained by regulatory agency servers. The records of database 295 include agency field 801, which identifies a particular regulatory agency, and access information field 802, which includes data usable to access data maintained by the associated agency. The data of access information field 802 may include any information usable to access a data repository according to any communication protocol. Moreover, the data stored in regulatory agency database 295 may be received from regulatory agency data repositories such as servers 400 and 410, from an operator of user administration server 200, or from requirements fulfillment application 291.

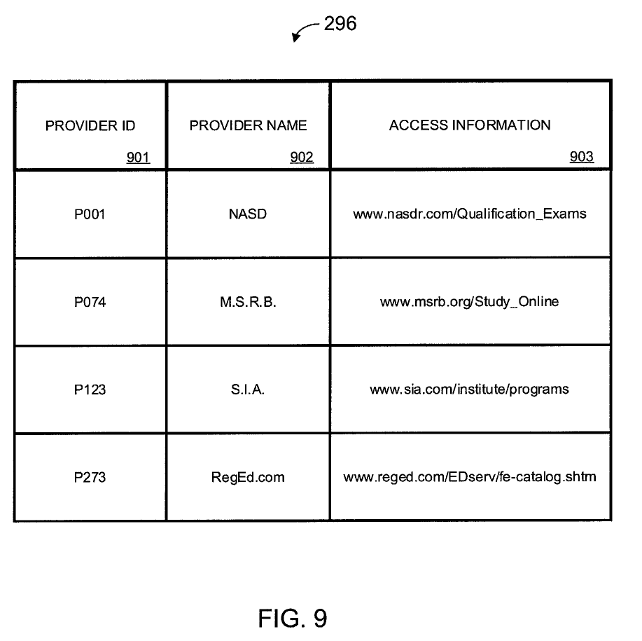

The tabular portion of fulfillment provider database 296 illustrated in FIG. 9 stores information describing servers operated by fulfillment providers and usable to access data maintained by the servers. Specifically, each illustrated record includes data populating provider Id field 901, provider name field 902 and access information field 903.

Provider Id field 901 of a record includes an identifier of a provider associated with the record. Provider name field 902 identifies the associated provider, and access information field 903 includes information usable to access a data repository maintained by the associated provider, such as fulfillment provider servers 500 and 510. The data stored in fulfillment provider database 295 may be received from such repositories, from an operator of user administration server 200, or from requirements fulfillment application 291.

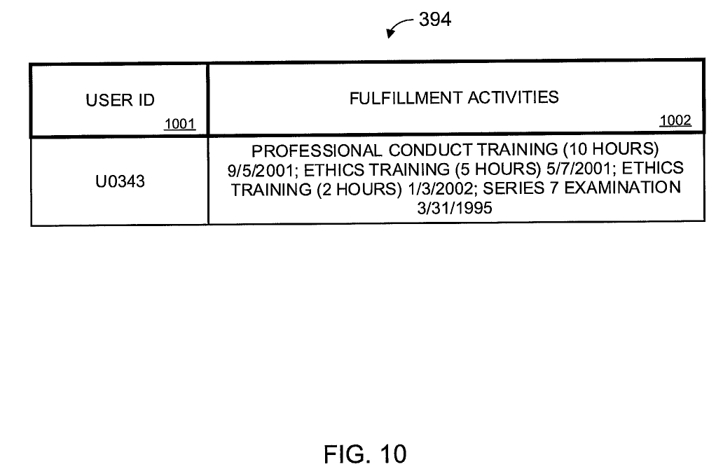

FIG. 10 illustrates a tabular representation of a portion of user information database 394. As shown, user information database 394 includes information identifying and characteristics of a user or users operating user device 300. In particular, the fields of each record of user information database 394 include user Id field 1001 and fulfillment activities field 1002.

User Id field 1001 of a record includes an identifier identifying a user who is the subject of a record. In some embodiments, the identifier may be used to determine information associated with the user in user database 293. Fulfillment activities field 1002 specifies fulfillment activities completed by an associated user. The completed fulfillment activities may be used to determine unfulfilled regulatory requirements associated with the user as described below. Fulfillment activities field 1002 may be populated by an associated user, by data received from fulfillment provider server 500, or by other means.

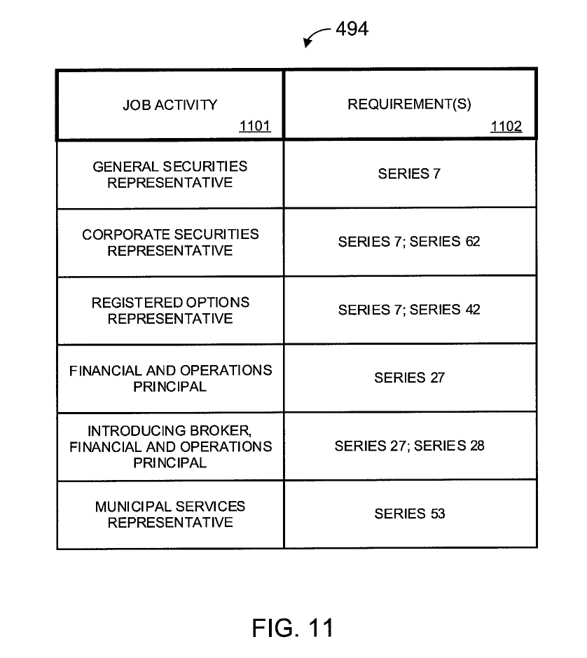

FIG. 11 illustrates a tabular representation of a portion of regulatory requirements database 494. The portion includes several records, each including job activity field 1101 and requirement(s) field 1102. In each record, requirement(s) field 1102 associates one or more regulatory requirements with a job activity specified in job activity field 1101. Accordingly, regulatory requirements may be determined based on job activities using regulatory requirements database 494. The regulatory requirements specified in regulatory requirements database 494 may include requirements applicable to a range of companies and employees, such as Regulatory Element modules promulgated by NASDR.

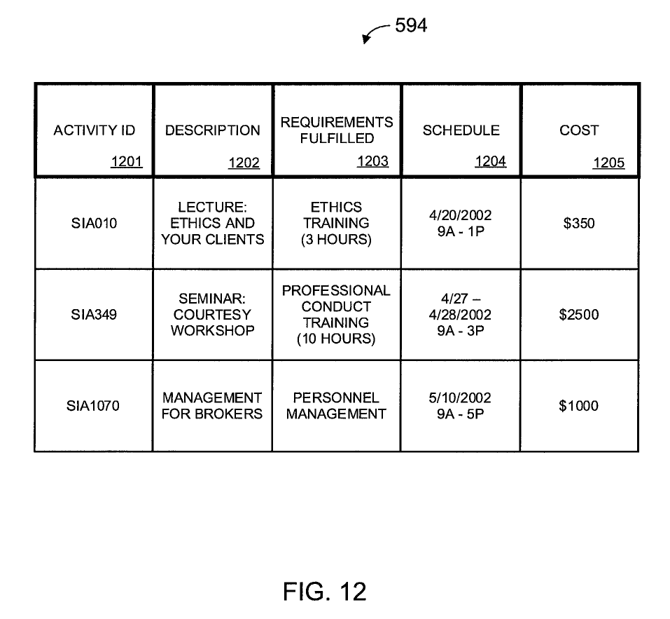

A representation of a tabular portion of fulfillment activity database 594 is illustrated in FIG. 12. Each record of fulfillment activity database 594 stores information associating fulfillment activities with regulatory requirements that the activities are usable to fulfill. More particularly, each record includes activity Id field 1201, description field 1202, requirements fulfilled field 1203, schedule field 1204, and cost field 1205. As will be described in detail below, the information specified in each of these fields is used to determine fulfillment activities usable to fulfill regulatory requirements associated with a user and to efficiently present the determined fulfillment activities to the user and/or to other interested parties.

It should be noted that the illustrations and accompanying descriptions of databases included herein merely represent relationships between stored information. A number of other arrangements may be employed besides those suggested, including arrangements in which some or all of the specified data is located remote from the device with which it is associated herein. It is further contemplated that each of the databases may include many more records than those shown and that each record may include associated fields other than those illustrated.

Process Flow

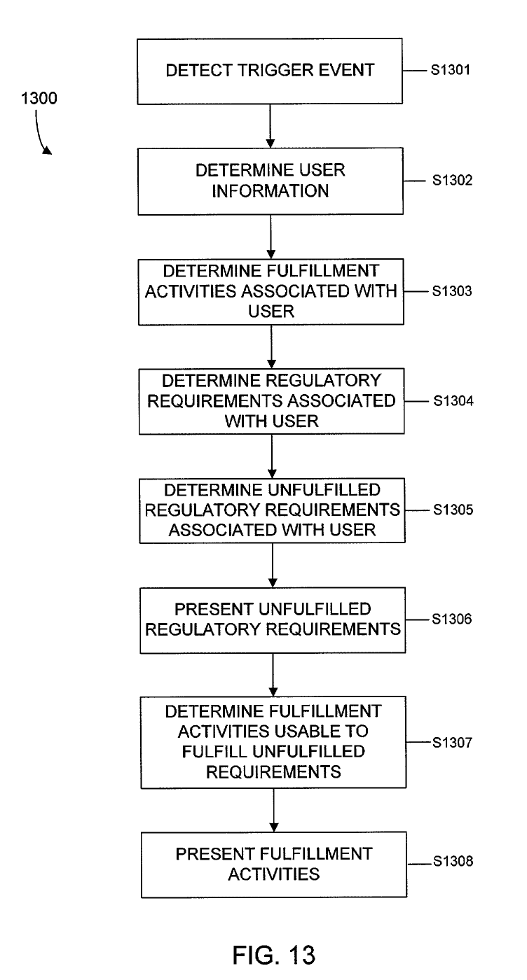

FIG. 13 comprises a flow diagram of process steps 1300 according to some embodiments of the present invention. Process steps 1300 are described below as if embodied in requirements fulfillment application 291 and executed by microprocessors 210 of user administration server 200. However, process steps 1300 may be embodied in one or more software or hardware elements and executed, in whole or in part, by any device or by any number of devices in combination, including user device 300, regulatory agency server 400, and fulfillment provider server 500. Moreover, some or all of process steps 1300 may be performed manually.

Initially, at step S1301, a trigger event is detected. The trigger event may comprise one or more of a myriad of events. For example, the trigger event may comprise the arrival of a particular date and time or the elapse of a particular time period. In this regard, requirements fulfillment application 291 may be configured to execute process steps 1300 at particular times or at particular periodic intervals. The particular times and intervals may vary depending upon the subject user. In one example, the trigger time or period corresponding to users employed by one company differs from the trigger time or period corresponding to users employed by another company. Time-based trigger events such as these may be detected using a clock (unshown) of user administration server 200.

In other examples, the trigger event comprises a regulatory requirement update. Such an event may be detected by receiving a notification of a requirement update from a regulatory agency server or another device. The trigger event may also comprise completion of a fulfillment activity. Detection of this completion may comprise reception of an indication of completion of the fulfillment activity from a fulfillment provider server or another device. Other trigger events that may be detected in step S1301 include a change in characteristics associated with a user and transmission of a request for an indication of one or more unfulfilled regulatory requirements from a user of user device 300 or from an operator of user administration server 200. It should be noted that a trigger event according to some embodiments of the present invention may comprise any combination of the above and other suitable trigger events.

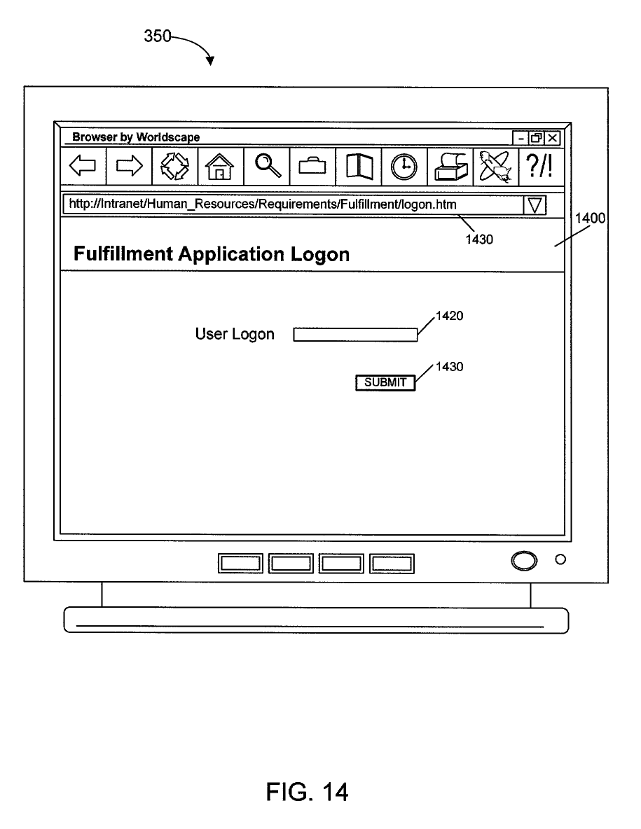

User information is determined in step S1302 in response to the detected trigger event. The user or users to whom the determined information corresponds may be those users associated with the detected trigger event or users otherwise specified. For purposes of the present example, it will be assumed that the determined user information corresponds to a single user. More particularly, it will be assumed that the single user operated user device 300 prior to step S1301 in order to request an indication of unfulfilled regulatory requirements from user administration server 200. FIG. 14 illustrates an outward view of a user interface that is used in some embodiments to submit such a request.

As shown, display 350 of user device 300 presents user interface 1400 comprising a Web page displayed by a window of Web client 392. In order to access user interface 1400, the user inputted a Uniform Resource Locator in address bar 1410 of the window and, in response, Web client 392 transmitted a request for a corresponding Web page to user administration server 200. Requirements fulfillment application 291 then operates in conjunction with Web server 292 to transmit the Web page shown in FIG. 14 from user administration server 200 to user device 300.

In order to request an indication of unfulfilled regulatory requirements, the user inputs identifying information such as a user Id, logon name and/or password into identification area 1420 and selects Submit button 1430. A request is then transmitted to and detected by user administration server 200 in step S1301.

As mentioned above, user information associated with the user from whom the request was received is determined in step S1302. The user information is determined in some embodiments by locating a record of user database 293 that is associated with the user. In a case that a user Id was input in identification area 1420, the user Id may be used to locate a record having an identical user Id specified in user Id field 601. If other information was input in area 1420, another data structure may be used to resolve a user Id from the other information. User information may also be determined in step S1302 by receiving user information from user device 300 and/or by retrieving user information from another device using submitted logon information.

Next, in step S1303, fulfillment activities associated with the user are determined. In some embodiments, the activities are determined by transmitting information identifying the user to fulfillment provider servers 500 and 510. Servers 500 and 510 attempt to locate records that associate completed fulfillment activities with the user, and transmit indications of any located completed fulfillment activities to user administration server 200. In some embodiments, transmitted to user administration server 200 during the above-described logon is fulfillment activity information from user information database 394. Accordingly, this information is used in step S1303 to determine fulfillment activity information.

Regulatory requirements associated with the user are determined in step S1304. As mentioned above, examples of these requirements include requirements issued by a traditional regulatory agency, by a parent company, by a company department and by an individual. These requirements may be mandatory, optional, or otherwise flexible in schedule and/or scope. According to some embodiments, determination of the requirements includes identification of requirements that are stored in requirements database 294 in association with user information determined in step S1302. For example, in a case that the subject user is associated with user Id “U0343”, it is determined in step S1302 that the subject user is associated with the corporate position “Vice President” and the location “New York”. Requirements database 294 associates these characteristics with the requirements—schedules “Ethics (10 hours)—every fiscal year” and “Professional Conduct Training (5 hours)—every fiscal year”. As a result, these regulatory requirements are determined in step S1304.

Requirements may also be determined in step S1304 by transmitting user information to regulatory agency servers such as servers 400 and 410 using information stored in regulatory agency database 295. Specifically, the received user information is used by regulatory agency servers 400 and 410 to locate regulatory requirements associated with the user information. Continuing with the above example, the user information “Corporate Securities Representative” associated with the subject user is associated with the requirements “Series 7” and “Series 62” in regulatory requirements database 494. These regulatory requirements may therefore be determined in step S1304.

Based on the information determined in steps S1303 and S1304, unfulfilled regulatory requirements associated with the user are determined in step S1305. Generally, the unfulfilled requirements are those requirements determined in step S1304 that have not been fulfilled by the completed fulfillment activities determined in step S1303. In the present example, the fulfillment activities associated with the user in user information database 394 and determined in step S1303 fulfill each regulatory requirement determined in step S1304 with the exception of 3 hours of Ethics Training and the Series 62 examination. Therefore, according to this specific example, the unfulfilled regulatory requirements determined in step S1305 are 3 hours of Ethics Training and the Series 62 examination.

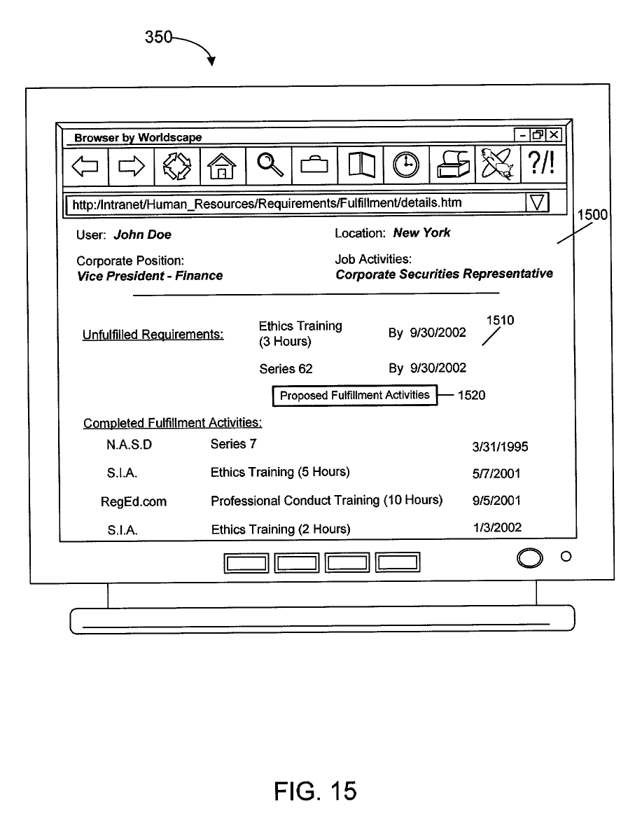

The unfulfilled regulatory requirements are presented in step S1306. Presentation of the requirements may include transmission of an indication of the unfulfilled regulatory requirements to a device such as user device 300, visual or audio presentation of the unfulfilled regulatory requirements to an operator of user administration server 200 via display 250 or printer 260, and/or visual or audio presentation of the unfulfilled regulatory requirements to a user through display 350 or printer 360. FIG. 15 shows an outward view of a user interface used to present the unfulfilled regulatory requirements according to some embodiments of the invention.

As shown, user interface 1500 includes unfulfilled requirements area 1510 for presenting to a user one or more unfulfilled regulatory requirements determined based at least on the user and on fulfillment activity information associated with the user. In accordance with some embodiments, area 1510 includes Proposed Fulfillment Activities button 1520. Selection of button 1520 causes Web client 392 to transmit a request for a Web page including fulfillment activities usable to fulfill the unfulfilled regulatory requirements. Also included in user interface 1500 is area 1530 for presenting the fulfillment activity information associated with the user.

The request that is transmitted upon selection of button 1520 may be transmitted to user administration server 200 and/or to one of fulfillment provider servers 500 and 510. The request may include an indication of the unfulfilled regulatory requirements for which fulfillment activities are desired. If the request is received by user administration server 200, the request is forwarded in step S1307 to one or more fulfillment provider servers using information stored in fulfillment provider database 296.

According to some examples, fulfillment provider server 500 uses fulfillment activity database 594 to locate fulfillment activities that are usable to wholly or partially fulfill the unfulfilled requirements. Information concerning the located activities in returned to user administration server 200, which presents the information in step S1308. As described with respect to step S1306, the information may be presented by means of a transmission to a device such as user device 300, a presentation to an operator of user administration server 200 via display 250 or printer 260, and/or a visual or audio presentation to a user through display 350 or printer 360.

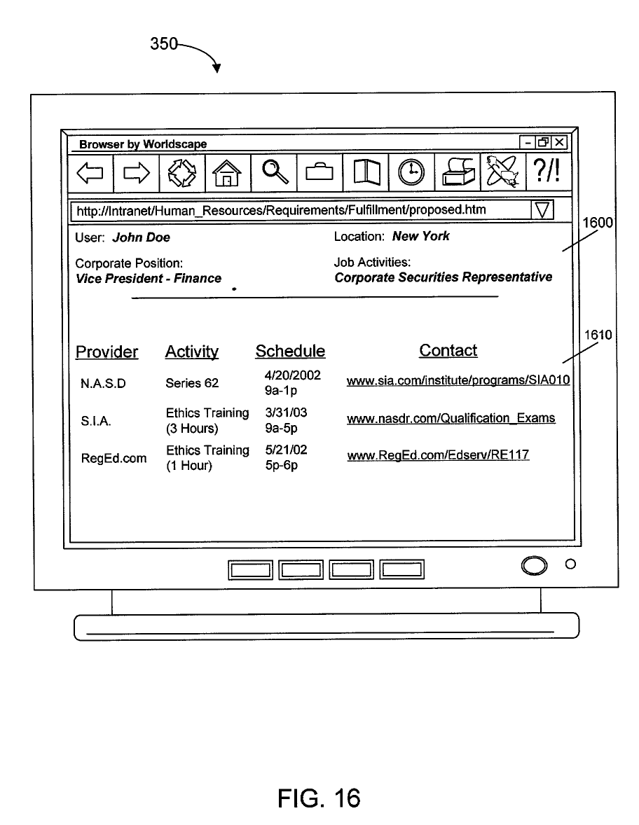

User interface 1600 of FIG. 16 presents the determined fulfillment activities to a user in step S1308. Specifically, user interface 1600 includes area 1610 for presenting fulfillment activities usable to fulfill one or more unfulfilled regulatory requirements. Again, the presented fulfillment activities need not be usable to completely fulfill one or more of the unfulfilled requirements, and some presented activities may more than fulfill one or more of the unfulfilled requirements. Moreover, two or more of the presented fulfillment activities may be individually usable to fulfill a same unfulfilled regulatory requirement.

Area 1610 of user interface 1600 provides information usable to contact providers of the presented fulfillment activities. In some embodiments, the information may be used to register for one or more of the fulfillment activities. Moreover, in some embodiments, a user may register for a presented fulfillment activity simply by selecting contact information associated with the activity in area 1610. Alternatively, step S1308 may comprise automatically registering a user for the fulfillment activities determined in step S1307.

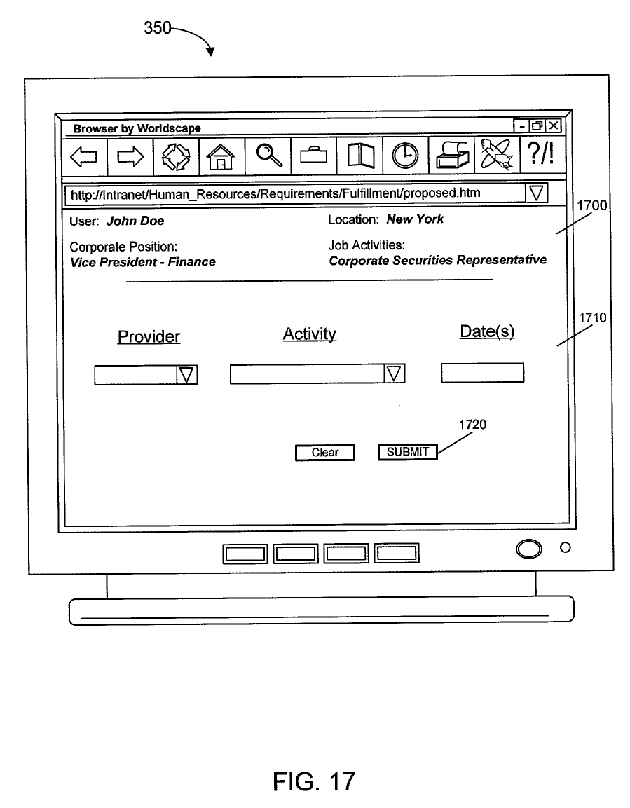

FIG. 17 illustrates an outward view of user interface 1700, which includes input area 1710 for receiving fulfillment activity information from a user. According to the illustrated embodiment, selection of Submit button 1720 causes any information input into area 1710 to populate fulfillment activities field 1002 of user information database 394. By virtue of one or more of the foregoing features, some embodiments of the present invention provide an efficient interface for facilitating fulfillment of regulatory requirements.

It should be noted that the user interfaces of FIGS. 14 through 17 may be considered a single user interface. Moreover, a user interface according to embodiments of the present invention may be arranged differently than as shown, with all or some of the features of user interfaces 1400 through 1700 located within one or more user interfaces.

In some embodiments, the user administration server 200 may be integrated with other devices operated by the company maintaining server 200. In one example of such integration, user administration server 200 monitors broker/client interactions maintained by an appropriate server to identify applicable requirements. For example, user administration server 200 may transmit a warning to a broker if the broker is dealing with a client located in a jurisdiction for which the broker has not fulfilled all applicable regulatory requirements. In some embodiments of this feature, user administration server 200 stores a customer database that includes address information for particular customers. The address information is used to determine whether a broker possesses all registrations required to conduct business with a particular customer. If not, server 200 may block the broker from interacting with the particular customer.

Some embodiments of the invention provide interfacing with registration depositories such as the Web CRD system. According to some of these embodiments, completed fulfillment activities input to interface 1700 by a user are transmitted to the registration depository for entry into its records. Additionally, the repository may transmit an online form such as the Form U-4 to user device 300 for completion and submission by a user. The Form U-4 may be transmitted to allow a user to amend U-4 information, such as address data or the like.

A Form U-4 associated with a broker/dealer company or individual must be amended in certain instances. For example, a broker/dealer must amend an associated Form U-4 if disciplined by a regulatory agency or if certain types of complaints (alleging damages over $10,000, theft, etc.) are lodged against the broker/dealer. Accordingly, embodiments of the present invention may be used to facilitate these amendments. In a specific example, data indicating the discipline of or the lodgment of a complaint against a broker/dealer is transmitted to user administration server 200 from regulatory agency server 400. Reception of this data serves as a triggering event that causes server 200 to transmit to the broker/dealer a user interface usable to amend an associated Form U-4.

Some embodiments of the invention may provide prospective evaluation of regulatory requirements. According to one example, user administration server 200 provides a user interface that allows a user to submit proposed amendments to associated user information. Applicable regulatory requirements are determined based on the proposed amendments and on the processes described above, and the determined requirements are presented to the individual. As described above, also presented may be an indication of which of the requirements are unfulfilled and/or of fulfillment activities that may be used to fulfill the unfulfilled requirements.

Although the foregoing examples consider regulatory requirements applicable to individuals, it should be noted that broker/dealer companies are also subject to regulatory requirements. As such, embodiments of the present invention may be used to determine unfulfilled requirements applicable to a company and to present the unfulfilled requirements to a company representative. The regulatory requirements applicable to a company may differ in whole or in part from the regulatory requirements applicable to employees of the company. In particular, company-related regulatory requirements may include new branch filings, requirements for holding a trading seat, or the like.

In addition, many of the embodiments described herein are directed to the regulatory requirements particular to the securities industry. However, embodiments of the present invention are applicable to many types of regulatory requirements, including but not limited to continuing education requirements, accreditation requirements, competency requirements, licensing requirements, and ethics requirements. Moreover, embodiments of the present invention may be used to facilitate the fulfillment of regulatory requirements relating to any number of fields, such as law, medicine, teaching, construction, or the like.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method comprising:
determining information associated with a user;
determining one or more regulatory requirements based at least on the information;
determining one or more unfulfilled regulatory requirements of the one or more regulatory requirements based at least on the information; and
presenting an indication of the one or more unfulfilled regulatory requirements to the user.

2. A method according to claim 1, further comprising:
receiving a request from the user for the indication of the one or more unfulfilled regulatory requirements.

3. A method according to claim 1, wherein the step of determining the one or more regulatory requirements comprises determining the one or more regulatory requirements based at least on a corporate position associated with the user.

4. A method according to claim 3, further comprising:
updating the corporate position associated with the user;
in response to the updating step, determining another one or more regulatory requirements based at least on the updated corporate position, the another one or more regulatory requirements being identical to, completely different from, or partially different from the one or more regulatory requirements; and
presenting an indication of another one or more regulatory requirements to the user.

5. A method according to claim 1, wherein the step of determining the one or more regulatory requirements comprises determining the one or more regulatory requirements based at least on job activities associated with the user.

6. A method according to claim 5, further comprising:
updating the job activities associated with the user;
in response to the updating step, determining another one or more regulatory requirements based at least on the updated job activities, the another one or more regulatory requirements being identical to, completely different from, or partially different from the one or more regulatory requirements; and
presenting an indication of another one or more regulatory requirements to the user.

7. A method according to claim 1, wherein the step of determining the one or more regulatory requirements comprises determining the one or more regulatory requirements based at least on a location associated with the user.

8. A method according to claim 7, further comprising:
updating the location associated with the user;
in response to the updating step, determining another one or more regulatory requirements based at least on the updated location, the another one or more regulatory requirements being identical to, completely different from, or partially different from the one or more regulatory requirements; and
presenting an indication of another one or more regulatory requirements to the user.

9. A method according to claim 1, wherein the step of determining the one or more regulatory requirements comprises determining the one or more regulatory requirements based at least on completed fulfillment activities associated with user.

10. A method according to claim 1, further comprising:
determining fulfillment activities usable to fulfill one or more of the one or more unfulfilled regulatory requirements; and
presenting the determined fulfillment activities to the user.

11. A method according to claim 10, wherein the step of determining fulfillment activities comprises:
querying a device operated by a fulfillment provider for fulfillment activities usable to fulfill one or more of the one or more unfulfilled regulatory requirements.

12. A method according to claim 10, wherein the step of determining fulfillment activities comprises:
identifying fulfillment activities associated with the one or more unfulfilled regulatory requirements based on a stored data structure associating fulfillment activities with regulatory requirements.

13. A method according to claim 1, wherein the step of determining regulatory requirements comprises:
querying a device operating by a regulatory agency.

14. A method according to claim 1, wherein the steps of the method are performed in response to detection of a triggering event.

15. A method according to claim 14, wherein detection of the triggering event comprises:
detecting an elapsed time period.

16. A method according to claim 14, wherein detection of the triggering event comprises:
detecting a regulatory requirement update.

17. A method according to claim 14, wherein detection of the triggering event comprises:
detecting completion of a fulfillment activity.

18. A method according to claim 17, wherein the step of detecting completion of a fulfillment activity comprises:
receiving an indication of completion of the fulfillment activity from a fulfillment provider.

19. A method according to claim 1, wherein one or more of the one or more regulatory requirements comprise requirements of a company employing the user.

20. A user interface for determining regulatory requirements, comprising:
an identification area for receiving information identifying a user; and
an unfulfilled requirements area for presenting to the user one or more unfulfilled regulatory requirements determined based at least on the user and on fulfillment activity information associated with the user.

21. A user interface according to claim 20, further comprising:
a fulfillment activity input area for receiving the fulfillment activity information from the user.

22. A user interface according to claim 20, further comprising:
an area for presenting fulfillment activities usable to fulfill one or more of the one or more unfulfilled regulatory requirements.

23. A user interface according to claim 20, further comprising:
a fulfillment activity area for presenting the fulfillment activity information to the user.

24. A method comprising:
inputting user information identifying a user;
receiving fulfillment activity information associated with the user; and
receiving unfulfilled regulatory requirements determined based at least on the user information and the fulfillment activity information.

25. A method according to claim 24, further comprising:
receiving regulatory requirements associated with the user, the regulatory requirements determined based at least on the user information.

26. A system comprising:
a user administration server for determining information associated with a user, determining one or more regulatory requirements based at least on the information, for determining one or more unfulfilled regulatory requirements of the one or more regulatory requirements based at least on the information, and for transmitting an indication of the one or more unfulfilled regulatory requirements; and
a user device for receiving the indication of the unfulfilled regulatory requirements, and for presenting the one or more unfulfilled regulatory requirements.

27. A system according to claim 26, further comprising:
a regulatory agency device for transmitting the regulatory requirements to the user administration server.

28. A system according to claim 26, further comprising:
a fulfillment provider device for transmitting fulfillment activities usable to fulfill one or more of the one or more unfulfilled regulatory requirements.

29. A system according to claim 28, wherein the user administration server receives the fulfillment activities usable to fulfill one or more of the unfulfilled regulatory requirements.

30. A system according to claim 26, wherein one or more of the one or more regulatory requirements comprise requirements of a company employing the user.
